(19) United States
(12) Patent Application Publication
(10) Pub. No.: US 2025/0319475 A1
(43) Pub. Date: Oct. 16, 2025

(54) Method of Separating Scrap Particles, and Particle Separation Assemby

(71) Applicant: Technische Universiteit Delft, Delft (NL)

(72) Inventors: Peter Carlo REM, Delft (NL); Francesco DI MAIO, Delft (NL)

(21) Appl. No.: 18/866,011

(22) PCT Filed: May 16, 2023
(86) PCT No.: PCT/NL2023/050276

§ 371 Date: Nov. 14, 2024

(30) Foreign Application Priority Data
May 17, 2022 (NL) 2031882

(51) Int. Cl. B03C 1/16; B03C 1/32

(52) U.S. Cl. CPC B03C 1/16; B03C 1/32

(57) ABSTRACT

Method of separating a mixture of scrap particles into fractions with different mass densities, comprising: feeding the mixture of scrap particles into a volume of ferrofluid held in a magnetic field configured for magnetic density separation of the scrap particles in the volume of ferrofluid; using the magnetic field, by the principle of magnetic density separation, causing the scrap particles in the volume of ferrofluid to become spatially distributed according to their mass densities along a separation direction having a horizontal component; while at least partly maintaining the spatial distribution, removing the scrap particles along a removal direction out of the volume of ferrofluid, the removal direction being substantially transverse to the separation direction; and, using the at least partially maintained spatial distribution, separating the removed scrap particles into fractions with different mass densities.

The invention relates to a method of separating a mixture of scrap particles into fractions with different mass densities, as well as to a particle separation assembly.

Such methods and assemblies are known as such, for example in the context of recycling of waste electric cable strands comprising a mixture of metals and plastics. In a known assembly, the principle of magnetic density separation (MDS) is employed to cause scrap particles in a volume of ferrofluid to become spatially distributed according to their mass densities, allowing subsequent separation into different fractions. Since different materials tend to have different mass densities, the resulting fractions can substantially correspond to different materials.

In known methods, the scrap particles move through narrow splitter openings. It has been found that, in particular for cable scrap particles, this can result in blockages. Also, in known methods, ferrofluid may be lost or degraded, resulting in excessive costs.

The present invention aims to at least partly resolve at least one of the above problems. Further aims are to provide a relatively reliable, precise, efficient and/or economic particle separation method, in particular for scrap particles from electric cable strands.

An aspect of the invention provides a method of separating a mixture of scrap particles into fractions with different mass densities. The method comprises: feeding the mixture of scrap particles into a volume of ferrofluid held in a magnetic field configured for magnetic density separation of the scrap particles in the volume of ferrofluid; using the magnetic field, by the principle of magnetic density separation, causing the scrap particles in the volume of ferrofluid to become spatially distributed according to their mass densities along a separation direction having a horizontal component; while at least partly maintaining the spatial distribution, removing the scrap particles along a removal direction out of the volume of ferrofluid, the removal direction being substantially transverse to the separation direction; and using the at least partially maintained spatial distribution, separating the removed scrap particles into fractions with different mass densities.

The mixture of scrap particles may comprise a mixture of different materials, e.g. metals and plastics. For example, the scrap particles may be electronic scrap particles, e.g. resulting from cutting or shredding electric cable strands.

From the above, it shall be understood that the term separation direction is used herein to refer to the direction along which the scrap particles in the volume of ferrofluid become spatially distributed according to their mass densities by the principle of magnetic density separation. So, as part of the separation, each of the particles will generally move to a position along this direction corresponding to its respective mass density. In traditional methods, this separation direction is typically vertical, i.e. not having a horizontal component, wherein particles will generally move to a respective position or level along the vertical direction that is lower for denser particles and higher for less dense particles. In such traditional methods, the separation is then typically completed using splitter openings arranged at different levels, wherein particles will generally approach and enter different splitter openings depending on their mass densities after having become vertically spatially distributed along the vertical separation direction, each splitter opening corresponding to a different fraction.

By the separation direction according to the present invention having a horizontal component and the removal direction being substantially transverse to the separation direction, the use of splitters as in known methods can advantageously be dispensed with, so that blockages can be avoided. Thus, by such a combination of geometrical features, a relatively simple and economical method can be provided, in particular with a common removal channel instead of the traditional splitters. Moreover, compared to such traditional methods, a relatively high degree of reuse of ferrofluid can be provided, as explained further elsewhere herein. Meanwhile, a single separation assembly, e.g. with a single volume of ferrofluid, may suffice to separate particles into a large number of fractions, in particular at least three fractions, for example four, five, six, seven or more fractions.

Within the volume of ferrofluid, contour lines of the magnetic field may extend substantially tilted. In this way, the separation direction can effectively be provided with a horizontal component while still supporting the principle of magnetic density separation.

In particular, such contour lines may slope downwardly from where the mixture of scrap particles is fed into the volume of ferrofluid. In this way, the resulting densities of the ferrofluid may effectively form a stack of downward slopes. After being fed into the volume of ferrofluid, in particular from above, a high density particle will then tend to follow a trajectory that is, at least on average, steeper compared to a low density particle, so that the particles can thereby be spatially distributed according to mass density along a separation direction having a horizontal component. For example, the spatial distribution may thus be a substantially horizontal distribution, in particular being along a substantially horizontal plane, e.g. a plane of a surface on which the particles land at the end of the aforementioned trajectories.

The separation direction, and/or end sections of the trajectories of the particles, may in particular be substantially parallel to the tilted contour lines of the magnetic field. Thereby, after initially mainly falling through the ferrofluid to a level corresponding to their mass density, the particles may subsequently mainly glide further through the ferrofluid along the separation direction, landing on corresponding different horizontal positions along the conveyor surface depending on the level to which they initially fell. Due to the substantially tilted contour lines, an end distribution of the particles may thus have a horizontal component, in particular be substantially horizontal, while being obtained from an initially mainly vertical distribution. From this, it may be further understood that the term separation direction as used herein refers to the direction along which the scrap particles in the volume of ferrofluid become spatially distributed according to their mass densities by the principle of magnetic density separation. The described separation direction thus has a horizontal component at least in the sense that the magnetic density separation can cause a horizontal component in the resulting particle distribution.

To support such horizontal separation, a feeding direction of the feeding preferably has a horizontal component, in particular being substantially aligned with the separation direction.

The feeding direction is preferably substantially transverse with respect to the removal direction, and/or vice versa, so that the spatial distribution can be maintained during and/or after the removing.

The removing is preferably performed using a conveyor surface which is permeable to the ferrofluid and impermeable to the scrap particles. In this way, it can be promoted that the ferrofluid remains behind when the particles are removed from the volume of ferrofluid, and/or that ferrofluid removed from the volume of ferrofluid along with the particles can drain away from the particles for recovery and reuse.

For at least partly maintaining the spatial distribution, the scrap particles may be caused to land on a section of the conveyor surface extending in the volume of ferrofluid, in particular at positions corresponding to the spatial distribution. Such a section of a conveyor surface may form an aforementioned substantially horizontal plane on which the particles can land. A further section of the conveyor surface may extend outside the volume of ferrofluid, so that when the conveyor surface is driven in the removal direction, particles which have landed on the conveyor surface can thereby be removed from the volume of ferrofluid.

In practice, the scrap particles may be removed from the volume of ferrofluid together with an adhering residue of ferrofluid. This may occur even when drainage is provided as explained above, in particular as a result of surface tension of the ferrofluid and/or affinity between the scrap particles and the ferrofluid. To reduce costs for replacing the relatively expensive ferrofluid, the method preferably comprises recovering at least part of the residue of ferrofluid from the removed scrap particles for reuse of the ferrofluid.

The recovering may comprise: exposing the removed scrap particles to a flow of gas, e.g. air, to thereby drive at least some of the residue of ferrofluid off the removed scrap particles; and capturing at least part of the driven off ferrofluid. The flow of gas is preferably directed substantially downwardly so as to substantially align with a direction of gravity along which the ferrofluid can drain.

It has been found that such a combination of a gas flow and gravity advantageously enables to drive off and drain most of the adhering ferrofluid from the removed scrap particles.

In a highly advantageous elaboration, the residue of ferrofluid is diluted prior to and/or during the recovering, in particular prior to and/or during the exposing to the flow of gas.

Although such diluting may initially slow down the recovery of the adhering ferrofluid, in particular the driving off by the flow of gas, it has been found that the overall yield of the recovery can be greatly improved thereby. Without wishing to be bound by theory, it is believed that this effect may be related to evaporation of part of the adhering residue of ferrofluid, in particular when exposed to a flow of gas: the evaporation may cause the remaining adhering ferrofluid to become more concentrated and therefore increasingly difficult to drive off or otherwise recover from the particles. By actively diluting the residue in place, i.e. while it adheres to the particles, this evaporation effect may be compensated, thereby allowing a greater amount of the residue to be recovered instead of remaining trapped with the scrap particles. The diluting is preferably such that, in combination with the aforementioned evaporation, the resulting concentration of the recovered ferrofluid is about the same as the original concentration of the ferrofluid, e.g. as present in the volume of ferrofluid.

The diluting of the residue preferably comprises supplying, e.g. spraying and/or misting, a diluent, e.g. water, for the ferrofluid onto the removed scrap particles.

The supplying of the diluent may be performed intermittently. In this way, one or more cycles of diluting and recovering may be effected, as needed, until the amount of residue remaining with the scrap particles is deemed sufficiently low, for example below about 5 mass %.

Alternatively, the supplying of the diluent could be performed for a single continuous period. In any case, the diluting is preferably stopped before the recovering, in particular the driving off, is stopped.

The recovered ferrofluid is preferably fed back to the volume of ferrofluid, preferably after having been filtered and/or mixed. In this way, ferrofluid lost from the volume of ferrofluid, in particular together with the removal of scrap particles, may be at least partly replenished, in particular without requiring a supply of new ferrofluid. A filter and/or a mixer, e.g. a passive mixer, may be provided to that end. Mixing of the recovered ferrofluid before being fed back can advantageously inhibit segregation.

A further aspect provides a particle separation assembly for separating a mixture of scrap particles into fractions with different mass densities. The particle separation assembly comprises: a container for holding a volume of ferrofluid; a feeder for feeding the mixture of scrap particles into the volume of ferrofluid; a magnet configured to cause a magnetic field configured for magnetic density separation of the scrap particles in the volume of ferrofluid; and a remover, preferably a conveyor, configured to remove the scrap particles out of the volume of ferrofluid.

The particle separation assembly is preferably configured for use in the method according to any of the preceding claims. In particular, the particle separation assembly may be configured to perform all or part of the method automatically.

Such a particle separation assembly provides corresponding advantages as explained above for the method.

The particle separation assembly may further comprise a fan assembly configured to expose the removed scrap particles to a flow of gas, e.g. air, to drive a residue of ferrofluid off the removed scrap particles.

As explained above, such a flow of gas can advantageously improve a recovery of ferrofluid from the removed particles.

The particle separation assembly is preferably configured to control a volume rate and/or a temperature of the flow of gas, and the method preferably comprises controlling said volume rate and/or temperature, in particular according to one or more predefined control parameters such as targets or ranges, and/or in dependence of an observed volume and/or concentration of recovered ferrofluid, and/or in dependence of a volume rate and/or temperature of a diluent supplied to the particles.

Primarily, such control of the flow of gas can promote removal of ferrofluid from the particles by drainage to thereby promote recovery of the ferrofluid. In this respect, it is noted that the flow of gas may be the main driver for causing initially adhering ferrofluid to be removed and drained from the particles, whereas the supply of diluent mainly serves to maintain a dilution level or low concentration of the ferrofluid still adhering to the particles.

Meanwhile, it has been found that such control of the flow of gas can enable manual and/or automatic regulation of evaporation of the ferrofluid, in particular to promote a relatively constant volume and/or concentration of the ferrofluid. To this end, as part of the control, the concentration of the drained ferrofluid may be evaluated, in particular compared to a target and/or reference such as a concentration of ferrofluid in the container.

The particle separation assembly may further comprise a diluent supply assembly, e.g. comprising one or more sprayers and/or misters, configured to supply a diluent, e.g. water, for the ferrofluid onto the removed scrap particles.

In this way, as explained above, a yield of the recovery of ferrofluid can be enhanced, thereby saving costs associated with supplying new ferrofluid.

In the following, the invention will be further explained using examples of embodiments and drawings. The drawings are schematic and merely show examples. In the drawings, corresponding elements have been provided with corresponding reference signs. In the drawings:

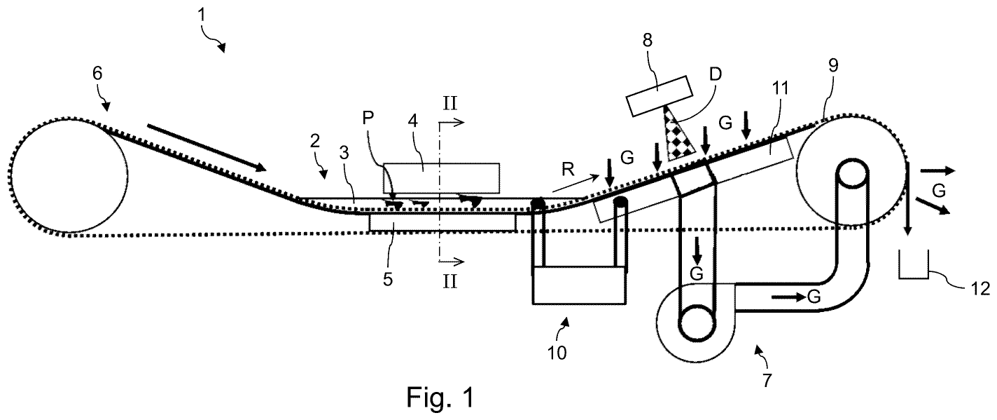

FIG. 1 shows a cross sectional side view of particle separation assembly;

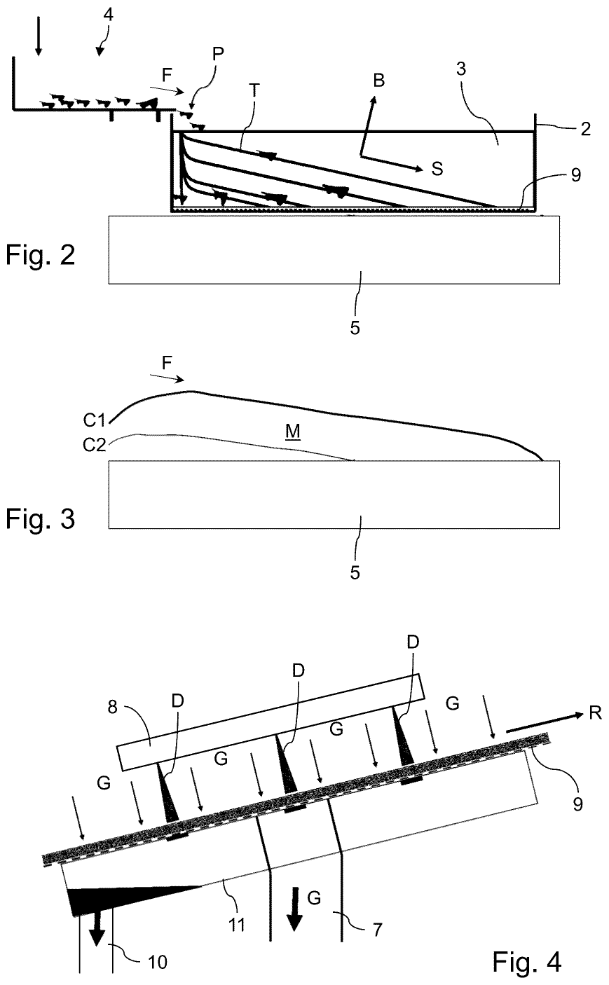

FIG. 2 shows a cross sectional view corresponding to line II-II in FIG. 1;

FIG. 3 shows contour lines of a magnetic field in a view corresponding to the view of FIG. 2;

FIG. 4 shows a cross sectional side view of part of a particle separation assembly according to a further example; and

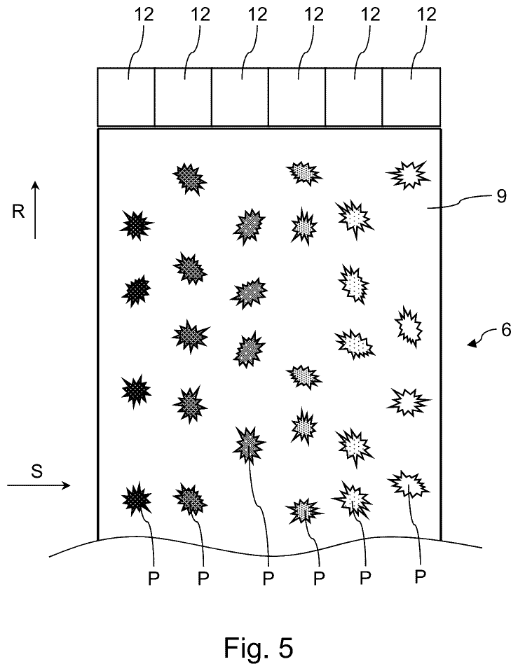

FIG. 5 shows a top view of a conveyor surface with particles distributed thereon, wherein different mass densities of the particles are illustrated by corresponding different hatching densities, and wherein bins corresponding to different fractions are shown at an end of the conveyor surface.

FIG. 1 shows a particle separation assembly 1 for separating a mixture of scrap particles P into fractions with different mass densities. The particle separation assembly 1 comprises: a container 2 for holding a volume of ferrofluid 3; a feeder 4 for feeding the mixture of scrap particles P into the volume of ferrofluid 3; a magnet 5 configured to cause a magnetic field M configured for magnetic density separation of the scrap particles P in the volume of ferrofluid 3; and a remover, here a conveyor 6, configured to remove the scrap particles P out of the volume of ferrofluid 3.

FIG. 2 shows a cross section along lines II-II in FIG. 1. FIG. 3 shows a view corresponding to FIG. 2, wherein examples of contour lines C1, C2 of the field strength of the magnetic field M have been indicated.

For clarity of the drawings, only some scrap particles P have been drawn, with only some of the drawn particles being indicated by reference sign P. It shall be appreciated that further and/or different scrap particles may be present, in particular also on the right hand side of the conveyor surface 9 in FIG. 2 and correspondingly on the conveyor surface 9 in FIG. 4. It shall be appreciated that scrap particles P can be of various shapes, sizes and compositions.

As will be understood from the present description, the particle separation assembly 1 is configured for use in a method of separating a mixture of scrap particles into fractions with different mass densities as described herein. In particular, the particle separation assembly 1 may be configured to perform said method automatically, e.g. under control of a correspondingly configured controller, which may be comprised by the assembly 1 and/or be external thereto.

With reference to FIG. 2, the method comprises feeding, e.g. using the feeder 4, the mixture of scrap particles P into a volume of ferrofluid 3 held in a magnetic field M (see FIG. 3) configured for magnetic density separation of the scrap particles P in the volume of ferrofluid 3. The volume of ferrofluid 3 may be held in the aforementioned container 2. The magnetic field M may be caused by the aforementioned magnet 5.

The method comprises, using the magnetic field M, by the principle of magnetic density separation (MDS), causing the scrap particles P in the volume of ferrofluid 3 to become spatially distributed according to their mass densities along a separation direction S having a horizontal component, e.g. as shown in FIG. 2. Here, it can be seen that, under influence of gravity, the particles P follow different downwardly sloped trajectories T (only one of which has been provided with a reference sign T for clarity of the drawing). Lower density particles follow a trajectory which is on average less steep compared to trajectories of higher density particles. As a result, the particles become spatially distributed according to their mass densities, here from high density on the left in FIG. 2 to low density on the right in FIG. 2. Thus, the resulting spatial distribution may be a substantially horizontal distribution, in particular being along a substantially horizontal plane.

To effect the downward sloping trajectories T, with reference to FIG. 3, within the volume of ferrofluid 3, contour lines C1, C2 of the magnetic field M may extend substantially tilted, in particular sloping downwardly from where the mixture of scrap particles P is fed into the volume of ferrofluid 3.

The method comprises, while at least partly maintaining the spatial distribution, removing the scrap particles P along a removal direction R out of the volume of ferrofluid 3, the removal direction R being substantially transverse to the separation direction S. For the shown examples, the removal direction R is best seen in FIG. 1. In FIG. 2, the removal direction extends into the plane of the drawing.

As seen in FIG. 2, for at least partly maintaining the spatial distribution, the scrap particles P are here caused to land on a section of the conveyor surface 9 extending in the volume of ferrofluid 3, in particular at positions corresponding to the spatial distribution. A possible resulting arrangement of particles P on the conveyor surface 9, substantially maintained after their landing, is illustrated in FIG. 5, wherein for illustration hatching density of the particles P is used to indicate their mass density.

The method comprises, using the at least partially maintained spatial distribution, separating the removed scrap particles P into fractions with different mass densities. Thereto, the removed scrap particles may be fed from the conveyor 6 into different bins 12 (see e.g. FIG. 5) corresponding to mutually adjacent ranges along the transverse direction of the conveyor 6, e.g. at the right hand side of FIG. 1. In FIG. 5, consistent with FIG. 2, denser particles P are received on the conveyor surface 9 further to the left and less dense particles P are received further to the right. Although six different bins 12 corresponding to six different density fractions are shown in FIG. 5, it shall be appreciated that different numbers of bins and fractions are possible.

A feeding direction F of the feeding (see e.g. FIG. 2) here has a horizontal component, in particular being substantially transverse with respect to the removal direction R and/or being substantially aligned with the separation direction S.

With reference to FIG. 1 and FIG. 5, the removing is here performed using a conveyor surface 9 of the conveyor 6. The conveyor surface 9 is permeable to the ferrofluid and impermeable to the scrap particles. For example, the conveyor surface 9 may be perforated and/or comprise a mesh, with openings smaller than the scrap particles but sufficiently large to drain ferrofluid therethrough. Such a conveyor surface 9 will generally also be permeable to gas, in particular from a flow of gas G explained elsewhere herein.

Although the conveyor 9 is permeable to the ferrofluid, the scrap particles P may still be removed from the volume of ferrofluid 3 together with an adhering residue of ferrofluid (not shown). With reference to FIGS. 1 and 4, the method then preferably further comprises recovering at least part of the residue of ferrofluid from the removed scrap particles P for reuse of the ferrofluid.

The recovering here comprises: exposing the removed scrap particles to a flow of gas G to thereby drive at least some of the residue of ferrofluid off the removed scrap particles P; and capturing at least part of the driven off ferrofluid.

Correspondingly, in the shown examples, the particle separation assembly 1 further comprises a fan assembly 7 (see FIG. 1) configured to expose the removed scrap particles to a flow of gas G to drive a residue of ferrofluid off the removed scrap particles. Since the conveyor surface 9 is also gas permeable, the substantially downward flow of gas G can here be caused by suction from under the conveyor assembly 9.

It can be seen in FIG. 1 that a same flow of gas G may be used further downstream to cause the scrap particles P to separate more easily from the conveyor surface 9, e.g. so as to reliably fall into different bins 12 depending on their transverse position on the conveyor surface 9, thereby creating fractions with different mass densities.

Further, the residue of ferrofluid is here diluted during the recovering, in particular during the exposing to the flow of gas G.

Correspondingly, in the shown examples (see FIGS. 1 and 4), the particle separation assembly 1 further comprises a diluent supply assembly 8 configured to supply a diluent D for the ferrofluid onto the removed scrap particles.

The diluting of the residue here comprises supplying, in particular spraying and/or misting, a diluent D, here water, for the ferrofluid onto the removed scrap particles.

In the example of FIG. 4, the supplying of the diluent is performed intermittently, whereas in the example of FIG. 1 the supplying is performed only for a single period as the particles are conveyed in the removal direction R along the conveyor surface 9.

In the shown examples, after draining through the conveyor surface 9, the ferrofluid is captured in a recovery tray 11. The recovered ferrofluid is subsequently fed back to the volume of ferrofluid 3, preferably after having been filtered and/or mixed, e.g. using a filter and/or mixing assembly 10 as indicated in FIG. 1. The filter and/or mixing assembly 10 may comprise a reservoir of ferrofluid and/or a pump and/or a sensor such as a pressure sensor, and may thus be configured to maintain a fluid level of the volume of ferrofluid within predetermined limits, at least as much as possible depending on the amount of ferrofluid actually recovered from the removed particles P.

The particle separation assembly 1, e.g. the filter and/or mixing assembly 10, may feed information from one or more sensors to a controller (not shown) associated with the particle separation assembly 1. In this way, the controller may adjust and/or recommend adjustment of the flow of gas G and/or the supply of diluent D in order to improve the recovery of ferrofluid using at least partially feed-back control.

Many variations will be apparent to the person skilled in the art. Such variations are understood to be comprised within the scope of the invention defined in the appended claims.

### LIST OF REFERENCE SIGNS

1. Particle separation assembly
2. Container
3. Volume of ferrofluid
4. Feeder
5. Magnet
6. Conveyor
7. Fan assembly
8. Diluent supply assembly
9. Conveyor surface
10. Filter and/or mixing assembly
11. Recovery tray
12. Bin
B. Mass density gradient
D. Supply of diluent
F. Feeding direction
G. Flow of gas
M. Magnetic field
P. Scrap particle
R. Removal direction
S. Separation direction
T. Particle trajectory

1. Method of separating a mixture of scrap particles into fractions with different mass densities, comprising:
feeding the mixture of scrap particles into a volume of ferrofluid held in a magnetic field configured for magnetic density separation of the scrap particles in the volume of ferrofluid;
using the magnetic field, by the principle of magnetic density separation, causing the scrap particles in the volume of ferrofluid to become spatially distributed according to their mass densities along a separation direction having a horizontal component;
while at least partly maintaining the spatial distribution, removing the scrap particles along a removal direction out of the volume of ferrofluid, the removal direction being substantially transverse to the separation direction; and
using the at least partially maintained spatial distribution, separating the removed scrap particles into fractions with different mass densities.

2. Method according to claim 1, wherein within the volume of ferrofluid, contour lines of the magnetic field extend substantially tilted, in particular sloping downwardly from where the mixture of scrap particles is fed into the volume of ferrofluid.

3. Method according to claim 1, wherein the spatial distribution is a substantially horizontal distribution, in particular being along a substantially horizontal plane.

4. Method according to claim 1, wherein a feeding direction of the feeding has a horizontal component, in particular being substantially transverse with respect to the removal direction and/or being substantially aligned with the separation direction.

5. Method according to claim 1, wherein the removing is performed using a conveyor surface which is permeable to the ferrofluid and impermeable to the scrap particles.

6. Method according to claim 5, wherein, for at least partly maintaining the spatial distribution, the scrap particles are caused to land on a section of the conveyor surface extending in the volume of ferrofluid, in particular at positions corresponding to the spatial distribution.

7. Method according to claim 1, wherein the scrap particles are removed from the volume of ferrofluid together with an adhering residue of ferrofluid, wherein the method further comprises recovering at least part of the residue of ferrofluid from the removed scrap particles for reuse of the ferrofluid.

8. Method according to claim 7, wherein the recovering comprises: exposing the removed scrap particles to a flow of gas to thereby drive at least some of the residue of ferrofluid off the removed scrap particles; and capturing at least part of the driven off ferrofluid.

9. Method according to claim 8, wherein the residue of ferrofluid is diluted prior to and/or during the recovering, in particular prior to and/or during the exposing to the flow of gas.

10. Method according to claim 9, wherein the diluting of the residue comprises supplying, e.g. spraying and/or misting, a diluent, e.g. water, for the ferrofluid onto the removed scrap particles.

11. Method according to claim 10, wherein the supplying of the diluent is performed intermittently.

12. Method according to claim 7, wherein the recovered ferrofluid is fed back to the volume of ferrofluid, preferably after having been filtered.

13. Particle separation assembly for separating a mixture of scrap particles into fractions with different mass densities, comprising:
a container for holding a volume of ferrofluid;
a feeder for feeding the mixture of scrap particles into the volume of ferrofluid;
a magnet configured to cause a magnetic field configured for magnetic density separation of the scrap particles in the volume of ferrofluid; and
a remover, preferably a conveyor, configured to remove the scrap particles out of the volume of ferrofluid,
wherein the particle separation assembly is configured for use in the method according to claim 1.

14. Particle separation assembly according to claim 13, further comprising a fan assembly configured to expose the removed scrap particles to a flow of gas to drive a residue of ferrofluid off the removed scrap particles.

15. Particle separation assembly according to claim 13, further comprising a diluent supply assembly configured to supply a diluent for the ferrofluid onto the removed scrap particles.

16. Method according to claim 1, wherein within the volume of ferrofluid, contour lines of the magnetic field extend substantially tilted, in particular sloping downwardly from where the mixture of scrap particles is fed into the volume of ferrofluid, wherein a feeding direction of the feeding has a horizontal component, in particular being substantially transverse with respect to the removal direction and/or being substantially aligned with the separation direction, wherein the removing is performed using a conveyor surface which is permeable to the ferrofluid and impermeable to the scrap particles, wherein, for at least partly maintaining the spatial distribution, the scrap particles are caused to land on a section of the conveyor surface extending in the volume of ferrofluid, in particular at positions corresponding to the spatial distribution.

17. Particle separation assembly for separating a mixture of scrap particles into fractions with different mass densities, comprising:
a container for holding a volume of ferrofluid;
a feeder for feeding the mixture of scrap particles into the volume of ferrofluid;
a magnet configured to cause a magnetic field configured for magnetic density separation of the scrap particles in the volume of ferrofluid; and
a remover, preferably a conveyor, configured to remove the scrap particles out of the volume of ferrofluid,
wherein the particle separation assembly is configured for use in the method according to claim 1, wherein the particle separation assembly is configured to perform the method automatically.

18. Particle separation assembly for separating a mixture of scrap particles into fractions with different mass densities, comprising:
a container for holding a volume of ferrofluid;
a feeder for feeding the mixture of scrap particles into the volume of ferrofluid;
a magnet configured to cause a magnetic field configured for magnetic density separation of the scrap particles in the volume of ferrofluid; and
a remover, preferably a conveyor, configured to remove the scrap particles out of the volume of ferrofluid,
wherein the particle separation assembly is configured for use in the method according to claim 8, wherein in particular the particle separation assembly is configured to perform the method automatically.

19. Particle separation assembly for separating a mixture of scrap particles into fractions with different mass densities, comprising:
a container for holding a volume of ferrofluid;
a feeder for feeding the mixture of scrap particles into the volume of ferrofluid;
a magnet configured to cause a magnetic field configured for magnetic density separation of the scrap particles in the volume of ferrofluid; and
a remover, preferably a conveyor, configured to remove the scrap particles out of the volume of ferrofluid,
wherein the particle separation assembly is configured for use in the method according to claim 16, wherein in particular the particle separation assembly is configured to perform the method automatically.

20. Method according to claim 7, wherein the residue of ferrofluid is diluted prior to and/or during the recovering, in particular prior to and/or during the exposing to the flow of gas.
